(19) United States
(12) Patent Application Publication
(10) Pub. No.: US 2026/0004548 A1
(43) Pub. Date: Jan. 1, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: KEISUKE MIDORIKAWA, Tokyo (JP)

(21) Appl. No.: 19/248,135

(22) Filed: Jun. 24, 2025

(30) Foreign Application Priority Data
Jun. 28, 2024 (JP) 2024-105701

(51) Int. Cl. G06V 10/26; G06V 10/764; G06V 10/82; G06V 20/70; G06V 40/10

(52) U.S. Cl. CPC G06V 10/273; G06V 10/82; G06V 20/70; G06V 10/764; G06V 40/10

(57) ABSTRACT

An image processing apparatus acquires an image, detects a plurality of types of subjects included in the image, acquires an evaluation value indicating certainty of a type of a subject for a region of a detected subject; and evaluates a type of a subject for a region of a subject detected. In a case where a region of a different type of subject overlaps with a region of a first subject that is detected, the apparatus acquires the evaluation value and evaluates a type of the first subject based on the evaluation value.

### BACKGROUND

### Field of the Technology

The present disclosure relates to an image processing apparatus, an image processing method, and a storage medium.

### Description of the Related Art

There is a known subject detection technology for automatically detecting a specific subject pattern from an image (Japanese Patent Laid-Open No. 2005-318554). Patent Document 1 discloses a capturing apparatus configured to detect a region corresponding to a specific subject pattern such as a face of a person from a shot image and optimize focus and exposure to the detected region. There is a known technology of causing a model including a neural network to train a feature of a subject (e.g., a dog) in an image using a technique called deep learning, and, after the learning, recognizing a subject (e.g., the dog) included in an image different from the image used for learning.

When performing subject detection from a captured image, it is possible to detect various types of subjects. However, in a case where various types of subjects can be detected, a plurality of different types of detection results may exist in a same region. In such a case, of the plurality of detection results, it is possible that all but one are false detections.

### SUMMARY

The present disclosure has been made in view of the above issues, and achieves a technology that can evaluate a type of a detected subject in a case where different detection results are obtained for a region of a subject in an image.

In order to solve the aforementioned issues, one aspect of the present disclosure provides an image processing apparatus comprising: one or more processors; and a memory storing instructions which, when the instructions are executed by the one or more processors, cause the image processing apparatus to function as: an image acquisition unit configured to acquire an image; a detection unit configured to be able to detect a plurality of types of subjects included in the image; an evaluation value acquisition unit configured to acquire an evaluation value indicating certainty of a type of a subject for a region of a detected subject; and an evaluation unit configured to evaluate a type of a subject for a region of a subject detected by the detection unit, wherein in a case where a region of a different type of subject overlaps with a region of a first subject that is detected, the evaluation unit acquires the evaluation value using the evaluation value acquisition unit, and evaluates a type of the first subject based on the evaluation value.

Another aspect of the present disclosure provides a method of controlling an image processing apparatus, the method comprising: acquiring an image; detecting a plurality of types of subjects included in the image; acquiring an evaluation value indicating certainty of a type of a subject for a region of a detected subject; and evaluating a type of a subject for a region of a subject detected in the detecting, wherein in a case where a region of a different type of subject overlaps with a region of a first subject that is detected, in the evaluating, the evaluation value is acquired by executing the evaluation value acquiring, and a type of the first subject is evaluated based on the evaluation value.

Still another aspect of the present disclosure provides a non-transitory computer-readable storage medium storing instructions for performing a method of controlling an image processing apparatus, the method comprising: acquiring an image; detecting a plurality of types of subjects included in the image; acquiring an evaluation value indicating certainty of a type of a subject for a region of a detected subject; and evaluating a type of a subject for a region of a subject detected in the detecting, wherein in a case where a region of a different type of subject overlaps with a region of a first subject that is detected, in the evaluating, the evaluation value is acquired by executing the evaluation value acquiring, and a type of the first subject is evaluated based on the evaluation value.

According to the present disclosure, it is possible to evaluate a type of a detected subject in a case where different detection results are obtained for a region of a subject in an image.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a functional configuration example of an image processing apparatus of the present embodiment.

FIG. 2 is a flowchart showing a series of operations of subject detection processing of a first embodiment.

FIG. 3 is a flowchart showing a series of operations of subject detection processing of a second embodiment.

FIGS. 4A to 4C are views describing examples of a crop region to be input to a type estimation CNN of an embodiment.

FIG. 5 is a view describing control according to subject priority setting of a third embodiment.

### DESCRIPTION OF THE EMBODIMENTS

### First Embodiment

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the following description, a case where a digital camera configured to be able to detect a subject in an image is used as an example of the image processing apparatus will be described. However, the present embodiment is applicable not only to a digital camera but also to other devices configured to be able to detect a subject in an image. These devices may include, for example, a smartphone, a game console, a tablet terminal, a medical device, and a device for a monitoring system.

### Configuration of Image Processing Apparatus

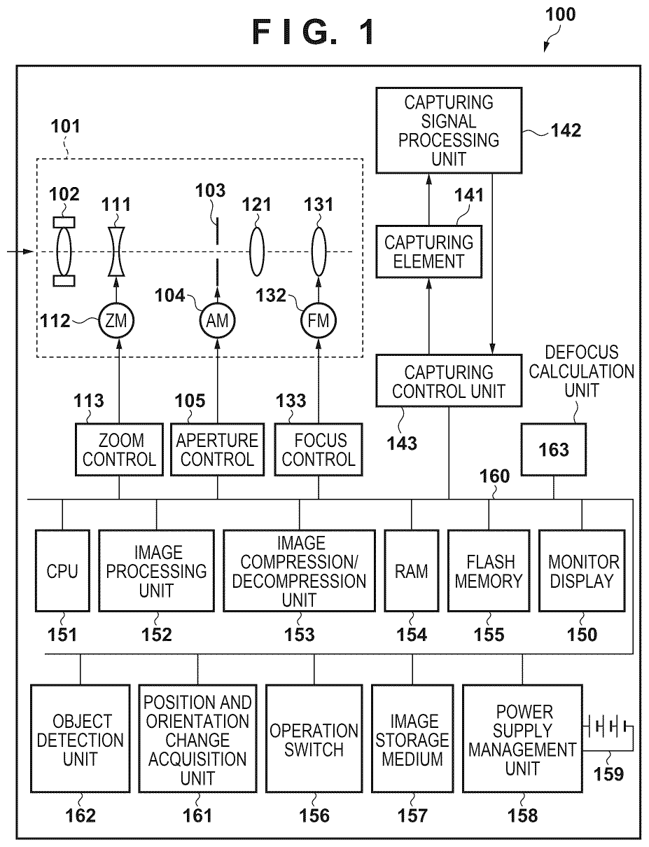

A configuration of an image processing apparatus of the present embodiment will be described with reference to FIG. 1. FIG. 1 illustrates a functional configuration example of an image processing apparatus 100. The image processing apparatus 100 is, for example, a digital still camera or a video camera configured to be able to shoot a subject and store data of a moving image or a still image on various media (e.g., a tape, an optical disk, a magnetic disk, a solid-state memory, or the like). Units in the image processing apparatus 100 are connected via a bus 160. Each unit is controlled by a CPU 151 (central processing unit) described later.

A lens unit 101 includes, for example, a fixed one-group lens 102, a zoom lens 111, an aperture 103, a fixed three-group lens 121, and a focus lens 131. The lens unit 101 further includes a zoom motor (ZM) 112, an aperture motor (AM) 104, and a focus motor (FM) 132. By driving the aperture 103 via the aperture motor 104 according to a command of a CPU 151, an aperture control unit 105 adjusts the aperture diameter of the aperture 103 to perform light amount adjustment at the time of shooting. A zoom control unit 113 changes the focal length by driving the zoom lens 111 via the zoom motor 112. A focus control unit 133 determines a drive amount for driving the focus motor 132 based on an out-of-focus amount (defocus amount) of the lens unit 101. In addition, by driving the focus lens 131 via the focus motor 132, the focus control unit 133 controls a focus adjustment state. AF (autofocus) control is achieved by movement control of the focus lens 131 by the focus control unit 133 and the focus motor 132. The focus lens 131 is a focus adjustment lens, and is simply illustrated as a single lens in FIG. 1, but usually includes a plurality of lenses.

A subject image formed on a capturing element 141 via the lens unit 101 is converted into an electric signal by the capturing element 141. The capturing element 141 includes a photoelectric conversion element configured to photoelectrically convert a subject image (optical image) into an electric signal. In the capturing element 141, light receiving elements of m pixels in the horizontal direction and n pixels in the vertical direction are arranged. An image formed on the capturing clement 141 and photoelectrically converted is adjusted as an image signal (image data) by a capturing signal processing unit 142, and an image on a capturing surface can be acquired.

Image data output from the capturing signal processing unit 142 is sent to a capturing control unit 143 and temporarily accumulated in a random access memory (RAM) 154. Image data accumulated in the RAM 154 is compressed by an image compression/decompression unit 153 and then stored in an image storage medium 157, which is a nonvolatile memory, for example. In parallel with this, the image data accumulated in the RAM 154 is sent to an image processing unit 152. The image processing unit 152 processes an image signal, and performs reduction/enlargement processing to an optimum size for the image data, similarity calculation between the image data, and the like. The image data processed to the optimum size is appropriately sent to and displayed on a monitor display 150, whereby preview image display or through image display can be performed. An object detection result of an object detection unit 162 can be superimposed on the image data. Furthermore, by functioning as a ring buffer, the RAM 154 buffers a plurality of pieces of image data captured within a predetermined period, a detection result of the object detection unit 162 corresponding to each piece of image data, a position and orientation change of the image processing apparatus acquired by a position and orientation change acquisition unit 161, and the like.

An operation switch 156 is an input interface including, for example, a touch panel and a button. A user can perform various operations on the image processing apparatus 100 by selecting and operating various function icons displayed on the monitor display 150.

The CPU 151 includes one or more processors. The CPU 151 controls each unit of the image processing apparatus 100 by executing a program stored in a flash memory 155 or the RAM 154. For example, the CPU 151 determines an accumulation time of the capturing element 141 and a set value of the gain when output from the capturing element 141 to the capturing signal processing unit 142 based on a user instruction from the operation switch 156 or the magnitude of a pixel signal of the image data accumulated in the RAM 154. The capturing control unit 143 receives instructions of the accumulation time and the set value of the gain from the CPU 151, and controls the capturing element 141.

Using image data (input image), the object detection unit 162 determines a region where a predetermined object exists. Although details described later, the object detection unit 162 can include, for example, an image acquisition function of acquiring an input image, a detection function of detecting a subject included in the input image, and an evaluation value acquisition function of acquiring an evaluation value of the type of the subject for a region of the detected subject. In the present embodiment, a machine learning model such as a convolutional neural network (CNN) trained using training data in advance can be used for detection of a subject and acquisition of an evaluation value of the type of the subject. The CNN is known as a representative neural network model used for deep learning. Note that in the present embodiment, a case where the CNN is used as a detector will be described as an example, but another machine learning model (e.g., a model such as a transformer including an attention mechanism) may be used.

The focus control unit 133 can achieve AF control for a subject region obtained by the object detection unit 162. The aperture control unit 105 can perform exposure control using a luminance value of the subject region obtained by the object detection unit 162. The image processing unit 152 performs gamma correction, white balance processing, and the like based on the subject region obtained by the object detection unit 162.

The monitor display 150 displays an image output from the image processing unit 152, an object detection result (e.g., a rectangle) by the object detection unit 162, and the like.

Note that in the description of the present embodiment, a case where the object detection unit 162 and the CPU 151 are separate is described as an example, but the operation of the object detection unit 162 may be executed by the CPU 151 executing a program stored in the flash memory 155. Alternatively, the object detection unit 162 may include a predetermined processing circuit, and the operation of the object detection unit 162 may be achieved by the processing circuit executing a program.

A battery 159 supplies power to each unit of the image processing apparatus 100. The battery 159 is appropriately managed by a power supply management unit 158, and can stably supply power to the entire image processing apparatus 100.

The flash memory 155 includes a nonvolatile memory, and stores a control program necessary for the operation of the image processing apparatus 100, parameters used for the operation of each unit of the image processing apparatus 100, and the like. When the image processing apparatus 100 is started by a user's operation (when shifting from a power-off state to a power-on state), the control program and parameters stored in the flash memory 155 are read into a part of the RAM 154. The CPU 151 controls the operation of the image processing apparatus 100 according to the control program and parameters read into the RAM 154. The control program may include a program for operating a machine learning model of the object detection unit 162. The parameters may include trained weight parameters constituting the machine learning model, and the like.

The position and orientation change acquisition unit 161 includes a position and orientation sensor such as a gyro, an acceleration sensor, or an electronic compass, for example, and measures a position and orientation change with respect to a shooting scene of the image processing apparatus 100. The acquired position and orientation change is saved in the RAM 154.

A defocus calculation unit 163 calculates a defocus amount from the image processing apparatus for an arbitrary subject in an image. The generated defocus information is saved in the RAM 154 and referred to by the image processing unit 152.

### Example of Machine Learning Model in Object Detection Unit 162

The object detection unit 162 of the present embodiment uses, as a detector, a machine learning model (e.g., CNN) configured to detect a subject in an image. The detector of the present embodiment outputs, for example, a rectangle region on an image corresponding to a region of a subject and reliability of a detection result. The reliability of a detection result is output as an integer value from 0 to 255, and for example, the larger the value is, the more likely the detection result is. The object detection unit 162 of the present embodiment uses a plurality of CNNs corresponding to the type of subject trained using separate training data for each type of subject in advance, such as a dog detection CNN trained using an image of a dog and a bird detection CNN trained using an image of a bird.

The object detection unit 162 of the present embodiment uses a machine learning model (e.g., CNN) that estimates the type of a subject existing in an input image, in addition to the CNN configured to detect a subject of a specific type. A CNN (type estimation CNN) that estimates the type of a subject functions as a classifier configured to classify the type of a subject in an input image. Output of the type estimation CNN includes likelihood corresponding to each of types of subjects determined in advance. The likelihood corresponding to each of the types is, for example, an integer value from 0 to 255 for each type. In a case where the type estimation CNN classifies a subject in an image into, for example, a person, a dog, a bird, and a horse (i.e., four types), the type estimation CNN outputs a vector including four integer values. The type estimation CNN is trained so that, for example, for an image of a person, the likelihood of the person is output as 255, and likelihoods of the other types are output as 0. Note that in a case where an image where no subject of any type exists is input, the type estimation CNN is trained so that all four values of the output are 0. At the time of inference, the object detection unit 162 adopts the maximum one of output likelihoods corresponding to the types output from the type estimation CNN. However, if the maximum value of the output likelihood is less than a predetermined threshold, the object detection unit 162 can determine that no subject of any type is included in the image. In this manner, the type estimation CNN outputs an evaluation value indicating the certainty of the type of the subject for a region of a detected subject. By using the evaluation value by the type estimation CNN, it is possible to evaluate the detection result of the CNN (i.e., detector) according to the type of the subject. In the present embodiment, in a case where detection results of a plurality of CNNs according to the type of subject overlap, the type of subject based on the CNN that has detected a specific subject such as a main subject and the type of subject based on the evaluation value of the type estimation CNN are compared (evaluated). In this manner, it is possible to evaluate a detection result that can include a false detection.

As described later, in the present embodiment, it is possible to determine the type of the subject in the region of a subject. For example, in a case where the types of the above-described comparison targets are different, the type of the subject in a region of a detected subject can be determined using the evaluation value by the type estimation CNN. That is, an appropriate type of the subject can be determined using the evaluation value by the type estimation CNN. This will be described in more detail below.

### Series of Operations of Subject Detection Processing

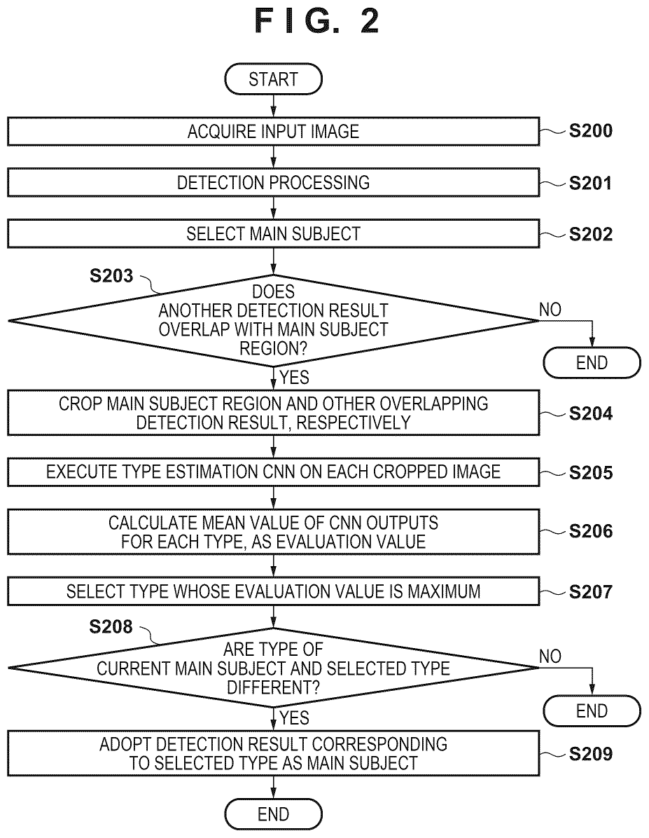

Next, a series of operations of the subject detection processing in the present embodiment will be described with reference to FIG. 2. The following subject detection processing is achieved by the CPU 151 executing a program stored in the flash memory 155. The operation of the object detection unit 162 may be executed by the CPU 151 executing a program stored in the flash memory 155. Alternatively, the operation of the object detection unit 162 may be achieved by a predetermined processing circuit of the object detection unit 162 executing a program.

In S200, the object detection unit 162 acquires, for example, via the RAM 154, image data (input image) supplied from the capturing control unit 143. In S201, the object detection unit 162 detects a subject in the input image. In the object detection unit 162, as described above, an independent detector according to a type of subject prepared in advance is used. For example, four types of CNNs of a person, a dog, a bird, and a horse are prepared in a trained state, and the object detection unit 162 executes the four CNNs in parallel for each frame. A region in which a subject is detected to exist by each CNN is a subject region.

In S202, the CPU 151 selects, as the main subject, a subject corresponding to a region most likely to be appropriate as the main subject from among the plurality of detected subjects. The main subject is a subject that is a target of processing such as AF and frame display. In a case where a plurality of subjects exist in an image, only one subject is the main subject. The main subject may be selected by an arbitrary method. For example, the CPU 151 can select the main subject based on at least any of the size of the region, the distance from the image center, and the distance from a range-finding area set by the user. The CPU 151 may select a subject of a specific type to be prioritized as a main subject according to detection of a subject of the specific type. For example, in a case where a subject whose type is person is detected, this person subject may be selected to be prioritized as a main subject. In a case where a main subject is not uniquely determined even in this manner, the CPU 151 can select, for example, a detection result having a large size to be prioritized as the main subject.

In S203, the CPU 151 determines whether or not a subject region (another subject region) different from the selected main subject region (main subject region) is detected in a form of overlapping with the main subject region. In the present embodiment, if it is possible to determine whether another subject region overlaps with the main subject region, the CPU 151 can perform the determination using an arbitrary method or an arbitrary threshold. For example, in a case where a ratio (IOU) of the area of an intersection region to the area of a union region of the main subject region and the other subject region) is 0.3 or more, the CPU 151 can determine that the main subject region and the other subject region overlap with each other. In a case of determining that the other subject region overlaps with the main subject region, the CPU 151 proceeds with the processing to S204, and otherwise, terminates the operation of the subject detection processing. Note that in a case of terminating in S203 the subject detection processing, the CPU 151 determines, as a type of the main subject, the type detected in the main subject region selected in S202, maintains the main subject region, and can perform arbitrary processing such as AF and frame display.

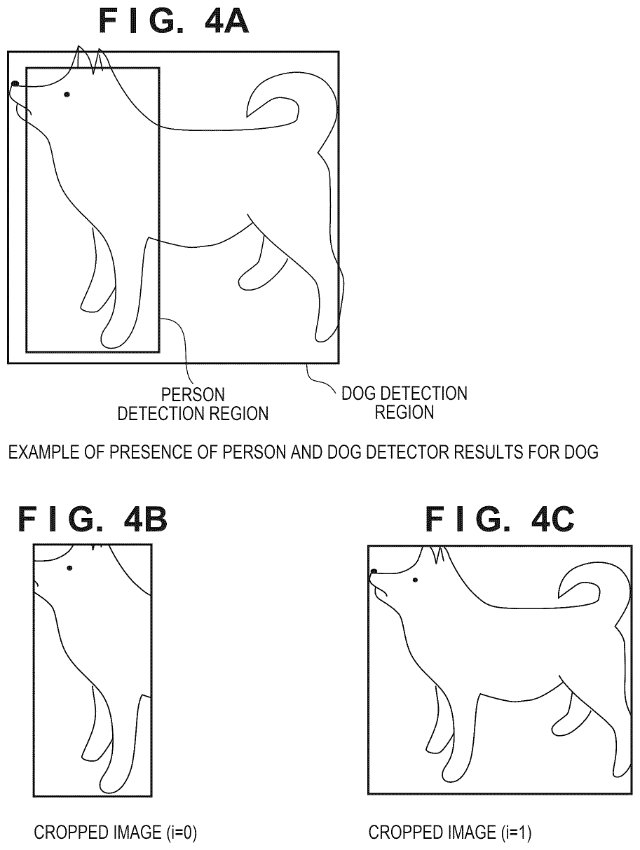

In S204, the CPU 151 performs crop processing for the main subject region and the region of another subject determined to overlap with the main subject region in S203, respectively. For example, in a case where a certain subject is detected as a “person” and a “dog” by two detectors as illustrated in FIG. 4A, the CPU 151 generates a cropped image of the person detection region illustrated in FIG. 4B and a cropped image of the dog detection region illustrated in FIG. 4C. Note that the CPU 151 may perform the crop processing on the subject region as it is, or may perform the crop processing on a region in which the subject region is scaled (enlarged or reduced) at a predetermined magnification. A region adjusted in the vertical direction or the horizontal direction in accordance with the aspect ratio of an input image of the type estimation CNN may be subjected to the crop processing.

In S205, the CPU 151 inputs each cropped image to the type estimation CNN, and executes the type estimation CNN. The object detection unit 162 executes inference processing by the type estimation CNN to estimate (classify) the type of the subject for each of the cropped images. At this time, the CPU 151 may resize the cropped image according to the size of the input image of the type estimation CNN as necessary. As described above, the type estimation CNN outputs a vector including four integer values indicating the likelihood (i.e., evaluation value indicating certainty of the type of the subject) for each type (e.g., four kinds of a person, a dog, a bird, and a horse). In the following description, the likelihood corresponding to the j-th type of the i-th cropped image is pⁱⱼ. For example, in the examples illustrated in FIGS. 4B and 4C, i=0, 1 (i=0 is the person detection region, and i=1 is the dog detection region). In a case where two subject regions determined to overlap with the main subject region in S203 exist, i=0, 1, and 2. In the example of the present embodiment, there are four types to be classified by the type estimation CNN, and the index j corresponds to j=0 for a person, j=1 for a dog, j=2 for a bird, and j=3 for a horse.

For example, the type estimation CNN outputs a result (e.g., {0, 255, 0, 0}) of estimating the type of the image in which the person detection region of i=0 is cropped, and subsequently outputs a result (e.g., {0, 255, 0, 0}) of estimating the type of the image in which the dog detection region of i=1 is cropped.

In S206, the CPU 151 calculates the mean value of the corresponding likelihoods of the CNN outputs for each type of subject. For example, the CPU 151 obtains the mean value of the likelihood of the j-th type according to Equation 1.

$$[ Equation 1 ]$$

$${\overline{p}}_{j} = {mean}_{i} ( {p}_{j}^{i} ) \qquad ( 1 )$$

In S207, the CPU 151 selects j that gives the maximum value of Equation 1, which is the mean value of the j-th type of likelihood, according to Equation 2. In an example of a result (e.g., {0, 255, 0, 0}) of estimating the type of the person detection region of i=0 and a result (e.g., {0, 255, 0, 0}) of estimating the type of the dog detection region of i=1, the mean value of the likelihood is, for example, {0, 255, 0, 0}. In this case, the type indicated by jₘₐₓ is j=1 (i.e., dog).

$$[ Equation 2 ]$$

$${j}_{max} = {argmax}_{j} ( {\overline{p}}_{j} ) \qquad ( 2 )$$

In S208, the CPU 151 determines whether the type of the current main subject (based on the main subject selected in S202) and the type indicated by jₘₐₓ calculated in Equation 2 are different from each other. In a case of determining that the type of the main subject and the type indicated by jₘₐₓ match each other, the CPU 151 terminates the subject detection processing. This is, for example, a case where the main subject selected in S202 is a subject detected by a person detection CNN, and the type indicated by jₘₐₓ calculated in Equation 2 is 0 (index indicating a person). In this case, it is possible to determine that the type (i=0) of the subject detected by the person detection CNN is certain. In this case, the CPU 151 can maintain the type and the region of the main subject selected in S202 and perform arbitrary processing such as AF and frame display. On the other hand, in a case of determining that the type of the current main subject and the type indicated by jₘₐₓ calculated in Equation 2 are different from (do not match) each other, the CPU 151 proceeds with the processing to S209.

In S209, in a case where the type of any of the other subject regions overlapping with the main subject region matches the type indicated by jₘₐₓ, the CPU 151 re-selects the subject (region or type) as the main subject. For example, in the example illustrated in FIG. 4A, it is assumed that the main subject region selected in S202 is a person detection region, and the dog detection region is determined to overlap with the main subject region in S203. Then, in a case where jₘₐₓ=1 (dog), the CPU 151 changes the main subject region to the dog detection region and changes the type of the main subject to dog.

Thereafter, the CPU 151 terminates the subject detection processing. Note that in a case where none of the types of subject regions overlapping with the main subject region matches jₘₐₓ, or in a case where the likelihood obtained by Equation 1 is less than a threshold, the CPU 151 terminates the subject detection processing without re-selecting the main subject. Note that at the time of termination of the subject detection processing, the CPU 151 may discard information on another subject overlapping with the subject that finally becomes the main subject.

As described above, in the above-described embodiment, the region of a subject is detected using the object detection unit 162 configured to be able to detect a plurality of types of subjects included in the acquired image. Then, in a case where a region of a different type of subject overlaps with the region of the detected subject, the likelihood (evaluation value) for the region of the subject detected using the type estimation CNN is acquired, and the type of the subject is evaluated based on the evaluation value. In this manner, in a case where a region of a different type of subject overlaps with the region of the detected subject, the type of the region of the subject detected by the detector of the object detection unit 162 can be appropriately evaluated. Furthermore, an appropriate subject type for the region of the subject is determined based on the evaluation value by the type estimation CNN. In this manner, even in a case where detection results of different types of subjects overlap with each other, it is possible to obtain an appropriate type for the region of the subject.

Note that in the above-described embodiment, the CPU 151 applies the type estimation CNN to each (i=0, 1) of the regions of subjects that overlap, and evaluates the type of the main subject based on the likelihood (evaluation value) for each of the regions of the subjects that overlap. However, the present embodiment is not limited to this example, and for example, the CPU 151 may apply the type estimation CNN to only one subject region (e.g., main subject) and evaluate the type of the subject based on the likelihood for the region of the subject. In this case, in a case where the type of the main subject and the type of the subject indicated by the likelihood by the type estimation CNN match each other, the type of the main subject can be maintained. On the other hand, in a case where the type of the main subject and the type of the subject indicated by the likelihood by the type estimation CNN do not match each other, the type estimation CNN may be applied to each of the regions of subjects that overlap, the likelihood for the plurality of cropped images may be calculated, and the type indicated by jₘₐₓ may be selected.

### Second Embodiment

Next, a second embodiment will be described. The second embodiment relates to processing of re-estimating a type of a main subject while tracking the main subject. Therefore, although a part of the subject detection processing is different from that of the above-described first embodiment, the configuration of the image processing apparatus 100 is similar. For this reason, the same or substantially the same configurations or processing are denoted by the same reference signs, the description thereof will be omitted, and differences will be mainly described.

### Series of Operations of Subject Detection Processing

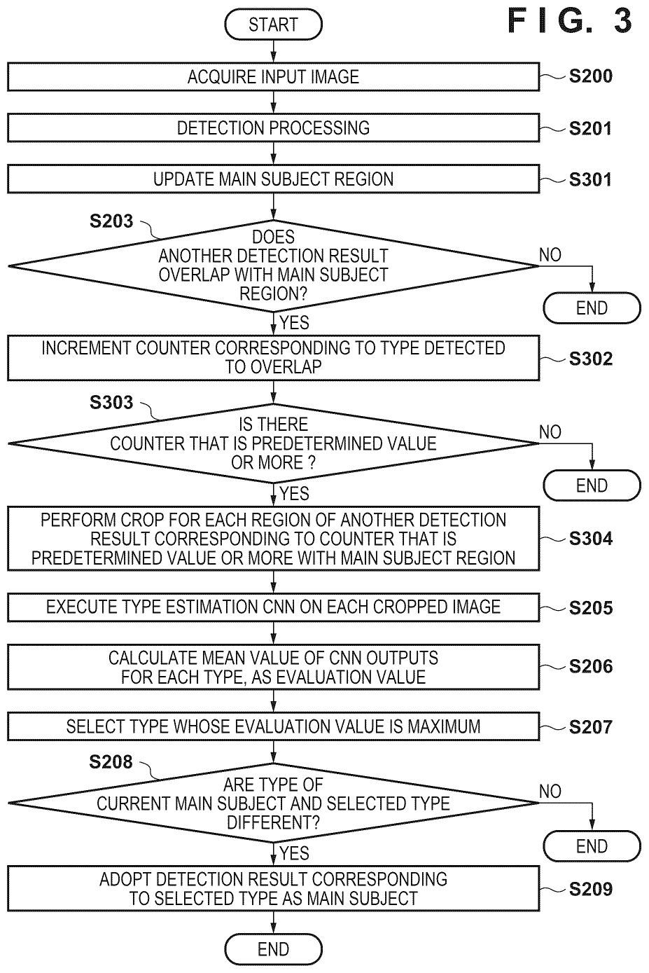

A series of operations of the subject detection processing in the second embodiment will be described with reference to FIG. 3. Note that in the present embodiment, a case in which a detection result exists only for one certain type (e.g., person) exists at the time point of determining the main subject, and another type (e.g., dog) is also detected from the middle is considered. In the subject detection processing in the present embodiment, in a case where the subject is correctly a dog, it is possible to correct the type of the main subject from person to dog. A distant small subject is detected as a main subject in a wrong type, but can be detected as a correct type as approaching the subject (becomes larger).

The following subject detection processing is achieved by the CPU 151 executing a program stored in the flash memory 155. The operation of the object detection unit 162 may be executed by the CPU 151 executing a program stored in the flash memory 155. Alternatively, the operation of the object detection unit 162 may be achieved by a predetermined processing circuit of the object detection unit 162 executing a program. Hereinafter, processing in one frame after the main subject is determined will be described.

In the processing from S200 to S201, similarly to the first embodiment, the object detection unit 162 acquires an input image to detect a subject in the input image.

In S301, the CPU 151 updates the region of the main subject. For example, the CPU 151 specifies and updates the region of the main subject of the current frame by executing template matching using the main subject region of the previous frame as a template. If there is a region of a subject of the same type as the main subject in the detection result obtained in S201, the CPU 151 may update the region of the main subject using the region.

In S203, similarly to the first embodiment, the CPU 151 determines whether or not a region of a subject different from the selected main subject is detected overlapping with the main subject region. In a case of determining that the region of the other subject overlaps with the main subject region, the CPU 151 proceeds with the processing to S302, and otherwise, terminates the operation of the subject detection processing.

In S302, the CPU 151 adds (increments) 1 to the value of a counter corresponding to the type of the detection result determined to overlap with the main subject region in S203. This counter is prepared for each type, and is, for example, four integer values of a person, a dog, a bird, and a horse in the present embodiment. Note that it is assumed that all are initialized to 0 at the timing when the main subject is determined.

In S303, the CPU 151 determines whether a counter that is a predetermined threshold or more exists. In the present embodiment, the threshold is 10, for example. In a case of determining that a counter that is the predetermined threshold or more exists, the CPU 151 proceeds with the processing to S304, and otherwise, terminates the operation of the subject detection processing.

In S304, the CPU 151 performs the crop processing on each region of the main subject region and the region of the detection result corresponding to the type in which the counter is the threshold or more. As described later, the counters corresponding to all types are initialized to 0 every time the type estimation CNN is executed. Therefore, by S303 and S304, the CPU 151 executes evaluation by the type estimation CNN only in a case where the value of the counter reaches the predetermined value. That is, in a case of acquiring an evaluation value using the type estimation CNN, the CPU 151 performs control not to acquire the evaluation value using the type estimation CNN for at least a predetermined period (i.e., evaluation of the subject type is not performed for the predetermined period). In this manner, it is possible to reduce adverse effects caused by applying the type estimation CNN in all frames and to improve processing speed. By S303 and S304, the types of subject regions on which the crop processing is performed can be limited (narrowed) to types having a counter value satisfying the threshold. For example, even in a case where the subject is detected for each of the four types, in a case where a type having a counter value satisfying the threshold is, for example, only person and dog, only person and dog subject regions may be cropped. Note that the crop processing can be performed similarly to the first embodiment.

Thereafter, the CPU 151 performs the processing from S205 to S209 similarly to the first embodiment. That is, based on the evaluation value by the type estimation CNN, the CPU 151 changes the main subject (region or type) to another subject or maintains the current main subject (region or type). Note that the CPU 151 may initialize the counters corresponding to all types to 0 every time S205 is executed (the type estimation CNN is executed).

### Third Embodiment

Next, a third embodiment will be described. The above-described embodiments are based on the premise that different types of subjects do not simultaneously exist in a same region. However, there is a case where different types of subjects actually exist in the same region, such as a scene where a person holds a dog. In a case where the type is changed in the above-described subject detection processing for such a scene, there is a case where the main subject is changed to the person unintentionally even in a case where the dog is desired to be the main subject. In this case, since both the person and the dog actually exist in the scene, it is true that the type estimation CNN outputs the ground truth regardless of which likelihood has a higher output.

Therefore, in the present embodiment, in a case where the user sets (hereinafter, subject priority setting) the type of subject to be prioritized as a main subject in a case where a different type of subject exists, the subject types that are the target of the subject detection processing are limited based on the subject priority setting.

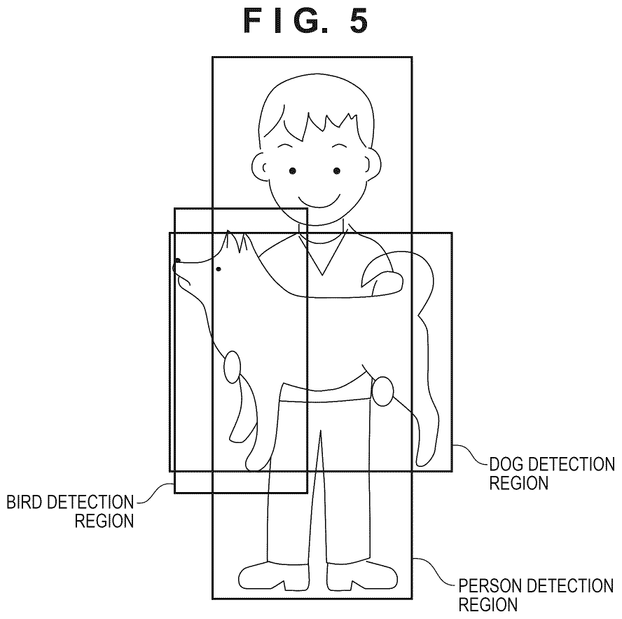

For example, as illustrated in FIG. 5, a case where a correct detection result for a person and a dog (by the person detection CNN and the dog detection CNN) and a result of false detection of a bird (by the bird detection CNN) in a scene where the person holds the dog will be described as an example.

In a case where the subject priority setting is set to prioritize a person, the CPU 151 determines the person as a main subject without performing the type estimation CNN in the example of FIG. 5. In a case where the subject priority setting prioritizes an animal, the dog or the bird is the type of the main subject according to the subject detection processing of the first embodiment or the second embodiment (the region is based on the output of the detection processing corresponding to the determined type). That is, the CPU 151 performs cropping based on each of a dog detection result and a bird detection result, and executes the type estimation CNN on each cropped image. That is, the CPU 151 limits the types of subject for which the evaluation value is acquired using the type estimation CNN to the type of the subject set by the subject priority setting. By this, when the likelihood of either of a dog and a bird is the highest, the CPU 151 determines the type of that subject as the type of the main subject.

There is a case where the subject priority setting is set to something other than person, dog, and bird (e.g., prioritization of a vehicle or the like), and priorities of person, dog, and bird are equivalent. In this case, the CPU 151 sets, as the type of the main subject, the type having the highest likelihood output by the type estimation CNN among person, dog, and bird according to the subject detection processing of the first embodiment or the second embodiment.

In this manner, by including the subject priority setting, even in a case where different types of subjects actually exist in the same region, the region of the intended subject can be determined as the region of the main subject.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-105701, filed Jun. 28, 2024 which is hereby incorporated by reference herein in its entirety.

What is claimed is:

1. An image processing apparatus comprising:
one or more processors; and
a memory storing instructions which, when the instructions are executed by the one or more processors, cause the image processing apparatus to function as:
an image acquisition unit configured to acquire an image;
a detection unit configured to be able to detect a plurality of types of subjects included in the image;
an evaluation value acquisition unit configured to acquire an evaluation value indicating certainty of a type of a subject for a region of a detected subject; and
an evaluation unit configured to evaluate a type of a subject for a region of a subject detected by the detection unit,
wherein in a case where a region of a different type of subject overlaps with a region of a first subject that is detected, the evaluation unit acquires the evaluation value using the evaluation value acquisition unit, and evaluates a type of the first subject based on the evaluation value.

2. The image processing apparatus of claim 1, wherein the instructions further cause the image processing apparatus to function as a determination unit configured to determine a type of the first subject based on the evaluation value for the region of the first subject.

3. The image processing apparatus of claim 1, wherein the evaluation unit evaluates a type of the first subject based on the evaluation value for the region of the first subject acquired by the evaluation value acquisition unit.

4. The image processing apparatus of claim 1, wherein the evaluation unit evaluates a type of the first subject based on the evaluation value for each of regions of overlapping subjects acquired by the evaluation value acquisition unit.

5. The image processing apparatus of claim 1, wherein in a case where the evaluation value is acquired using the evaluation value acquisition unit, the evaluation unit performs control not to acquire the evaluation value using the evaluation value acquisition unit for a predetermined period.

6. The image processing apparatus of claim 1, wherein the instructions further cause the image processing apparatus to function as a setting unit configured to set a type of a subject to be prioritized as a main subject,
wherein the evaluation unit limits a type of a subject for which the evaluation value is acquired using the evaluation value acquisition unit to a type of a subject set by the setting unit.

7. The image processing apparatus of claim 2, wherein in a case where a region of a different type of subject does not overlap with the region of the first subject, the determination unit sets, as a type of the first subject, a type of a subject detected by the detection unit in the region of the first subject.

8. The image processing apparatus of claim 1, wherein the evaluation unit evaluates a type of the first subject by comparing a type of a first subject based on the detection unit that has detected a first subject with a type of the first subject based on the evaluation value.

9. The image processing apparatus of claim 2, wherein:
the evaluation unit evaluates a type of the first subject by comparing a type of a first subject based on the detection unit that has detected a first subject with a type of the first subject based on the evaluation value, and
in a case where a type of a first subject based on the detection unit that has detected a first subject and a type of the first subject based on the evaluation value do not match each other, the determination unit determines a type of the first subject based on the evaluation value for the region of the first subject.

10. The image processing apparatus of claim 1, wherein:
the evaluation value acquisition unit acquires the evaluation value for each type of a subject determined in advance for a region of a subject that is detected, and
the evaluation unit evaluates a type of a subject of the first subject using a type of a subject having the evaluation value that is maximum.

11. The image processing apparatus of claim 10, wherein the evaluation value acquisition unit includes a machine learning model configured to input a region of a subject that is detected and output the evaluation value for each type of subject determined in advance.

12. The image processing apparatus of claim 1, wherein:
the detection unit includes a machine learning model trained to detect a subject of a specific type, and
in a case where the evaluation value by the evaluation value acquisition unit for a region of a subject of a specific type is highest for the specific type, the evaluation unit evaluates the specific type as a type of the first subject.

13. The image processing apparatus of claim 1, wherein the instructions further cause the image processing apparatus to function as a selection unit configured to select a region of a main subject from regions of a plurality of subjects that are detected,
wherein a region of the first subject is a region of a main subject.

14. The image processing apparatus of claim 1, wherein the instructions further cause the image processing apparatus to function as a cropping unit configured to crop, based on a result of a detection by the detection unit, a region in an image as a region of a subject that is detected.

15. A method of controlling an image processing apparatus, the method comprising:
acquiring an image;
detecting a plurality of types of subjects included in the image;
acquiring an evaluation value indicating certainty of a type of a subject for a region of a detected subject; and
evaluating a type of a subject for a region of a subject detected in the detecting,
wherein in a case where a region of a different type of subject overlaps with a region of a first subject that is detected, in the evaluating, the evaluation value is acquired by executing the evaluation value acquiring, and a type of the first subject is evaluated based on the evaluation value.

16. A non-transitory computer-readable storage medium storing instructions for performing a method of controlling an image processing apparatus, the method comprising:
acquiring an image;
detecting a plurality of types of subjects included in the image;
acquiring an evaluation value indicating certainty of a type of a subject for a region of a detected subject; and
evaluating a type of a subject for a region of a subject detected in the detecting,
wherein in a case where a region of a different type of subject overlaps with a region of a first subject that is detected, in the evaluating, the evaluation value is acquired by executing the evaluation value acquiring, and a type of the first subject is evaluated based on the evaluation value.
